(19) United States
(12) Patent Application Publication
(10) Pub. No.: US 2006/0146668 A1
(43) Pub. Date: Jul. 6, 2006

(54) System and method for multi-laser write operations to an optical medium

(76) Inventor: Thomas L. Pratt, Austin, TX (US)

Correspondence Address: HAMILTON & TERRILE, LLP, P.O. BOX 203518, AUSTIN, TX, 78720, US

(21) Appl. No.: 11/029,527

(22) Filed: Jan. 5, 2005

(51) Int. Cl. G11B 5/09; G11B 19/00

(52) U.S. Cl. 369/47.5; 369/59.11

(57) ABSTRACT

An information handling system optical drive improves information write speeds by using multiple lasers in conjunction with each other to perform a write to an optical medium data or label surface. One or more lasers illuminate the optical medium at a preheat spot with a preheat power and one laser selectively illuminates the optical medium proximate the preheat spot to alter the reflective material of the optical medium and write information. For instance, an infrared associated with CD optical media and/or a red laser associated with a DVD optical media illuminate the optical medium with a loose focus to preheat the optical medium while a blue laser associated with high definition DVD optical media illuminates the optical medium to write information at the preheated area. Preheating allows the blue laser to alter the reflective material of the optical medium in a write operation performed at a more rapid spin rate than occurs without preheating.

### BACKGROUND OF THE INVENTION

1. Field of the Invention

The present invention relates in general to the field of writing information to an optical medium, and more particularly to a system and method for multi-laser write operations to an optical medium.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling systems have become more common and have improved in the speed at which they process information, increasing amounts of information have been generated for storage. Optical media provide a sensible and relatively inexpensive solution for storing large quantities of information on a portable material. Generally, an optical medium stores information by altering the reflective qualities of a data layer material with a focused laser and allows retrieval of information by reflection of the focused laser against the altered material to measure the reflected light characteristics. However, the precise characteristics of optical media vary widely to accommodate different storage speeds, densities and functions. For instance, writable optical medium discs (-R or +R discs) accept a single information write over the reflective material. By comparison, re-writable optical medium discs (RW) accept repeated information writes over the same material. Storage densities for optical media have increased from less than a gigabyte with infrared laser CD formats to several gigabytes with red laser DVD formats. Storage densities for the planned “Blu-ray Disc” blue laser high definition DVD format is expected to exceed twenty gigabytes. The higher density red and blue laser optical media generally come in the same physical size discs as infrared optical media but store greater densities by storing more information per track and/or placing more tracks of within a disc.

One disadvantage associated with the growing storage densities available on optical media is that writing greater amounts of information takes a longer amount of time. Generally, information is written to an optical medium by spinning the optical medium relative to a laser and heating the material of the optical medium with the laser to alter the material's reflective characteristics in a desired pattern. Information is written more quickly by spinning the optical medium more quickly, however, spinning an optical medium too quickly results in failed writes since the laser does not have enough time over the material to adequately alter the material's reflective characteristics. One solution is to use more powerful lasers that are able to alter an optical medium's reflective characteristics more rapidly, however, the use of more powerful lasers increases the cost of an optical drive and is limited by available laser technology and design. Another solution is to use more sensitive reflective material in the optical medium, however, more rapid information writes based on the optical medium material are dependent upon improvements in material design. Thus, although information handling system users appreciate increases in optical medium storage density, significant information writing times associated with writing to optical media creates some user frustration.

### SUMMARY OF THE INVENTION

Therefore a need has arisen for a system and method which increases the rate at which information is written to an optical medium having a predetermined reflective material with a laser having a predetermined power.

In accordance with the present invention, a system and method are provided which substantially reduce the disadvantages and problems associated with previous methods and systems for writing information to an optical medium. Multiple lasers apply energy to the optical medium to alter the reflective characteristics of the optical medium during a write.

More specifically, an optical drive includes plural lasers, each laser associated with a type of optical media, such as an infrared laser associated with CD media, a red laser associated with DVD media and a blue laser associated with a high definition DVD media like a Blu-ray Disc media. A write engine applies identification information of an optical medium inserted in the optical drive to select a write strategy for writing information to the optical medium with multiple lasers. A first laser or lasers illuminates a preheat spot on the optical medium to preheat the reflective material of the medium without energy sufficient to alter the reflective material in a write operation to the optical medium. A second laser selectively illuminates a primary writing spot proximate the preheat spot so that information is written to the optical medium at the primary writing spot. The preheating of the optical medium decreases the power needed by the second or primary laser to write information to the optical medium and thus allows a greater spin rate of the optical medium in the optical drive compared with a write by only the primary laser. Preheating may be performed by lasers that are not associated with the type of the inserted optical medium. For instance, infrared and/or red lasers may preheat for writing by a blue laser, infrared and/or blue lasers may preheat for writing by a red laser, and red and/or blue lasers may preheat for writes by an infrared laser. Further, writes with multiple lasers may be made to either the data or label sides of an optical medium.

The present invention provides a number of important technical advantages. One example of an important technical advantage is that multiple lasers apply energy to an optical medium to alter the reflective characteristics of the optical medium more rapidly than a single laser. Combining the power of two or more lasers available in an optical disc drive allows more energy to be imparted on the optical medium per unit time, thus allowing the disc to spin at a faster rate for more rapid writing completion. The ready availability of multiple lasers in most optical medium drives means that more rapid write times may be accomplished with minimal changes to existing optical disc drive designs and thus minimal cost.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an information handling system having an optical drive configured to write information to an optical medium with multiple lasers; and

FIG. 2 depicts a preheat spot and writing spot illuminated on an optical medium for writing information to the optical medium.

### DETAILED DESCRIPTION

Multiple lasers illuminate an optical medium to write information on the optical medium that is generated by an information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

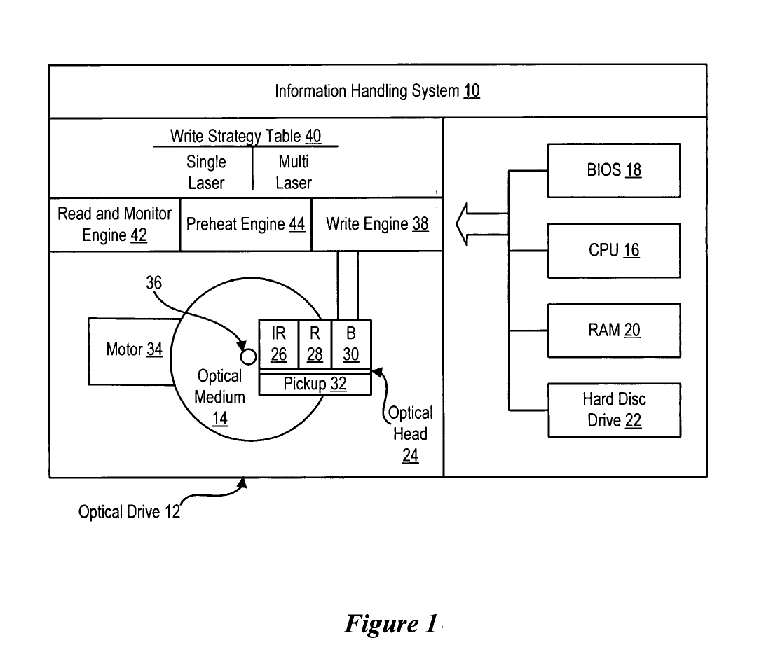

Referring now to FIG. 1, an information handling system 10 is depicted having an optical drive 12 configured to write information to an optical medium 14 with multiple lasers. Information handling system 10 includes processing components, such as a CPU 16, BIOS 18, RAM 20 and hard disc drive 22, that generate information for communication to optical drive 12 and storage on optical medium 14. For example, the generated information includes multimedia information, such as photographic, audio or movie files, that are written with a multimedia application communicating through an operating system driver for optical drive 12. Optical drive 12 writes information to different types of optical media by illuminating the optical media with lasers disposed on an optical head 24. For instance, optical head 24 has an infrared laser 26 for writing information to CD optical media, a red laser 28 for writing information to DVD optical media and a blue laser 30 for writing information to high definition DVD optical media such as Blu-ray Disc optical media. The optical media include writable media having a dye layer that is selectively heated to change its reflectivity or re-writable media having material that physically changes to alter its reflectivity. Optical head 24 reads information from optical medium 14 by illuminating the optical medium with its respective laser and sensing the reflective energy from the optical medium with a pickup unit 32. A motor 34 spins optical medium 14 about a spindle 36 to move optical medium 14 relative to optical head 24 during write and read operations.

A write engine 38 manages the writing of information communicated from the processing components to optical medium 14. Write engine 38 sets write parameters by reference to a write strategy table 40, which holds writing strategies for different types of optical media, including writes to an information side or a label side of the optical medium. For instance, a read and monitor engine 42 reads identification information from optical medium 14 on initial insertion of the optical medium into optical drive 12 and provides the identification information to write engine 38. Write engine 38 applies the identification information to write strategy table 40 to determine a write strategy for writing information, such as the appropriate laser, laser power setting and motor spin rate to use during the write. As an example, if the identification information indicates that optical medium 14 is a CD of a predetermined type, write engine 38 looks up the write strategy associated with the type and writes information to the optical medium with infrared laser 26 by selectively illuminating infrared laser 26 as motor 34 spins the CD about spindle 36. Similarly, red laser 28 is selectively illuminated to write information to DVD media and blue laser 30 is selectively illuminated to write information to high definition DVD media.

The rate at which information is written to optical medium 14 depends upon the rate at which motor 34 spins optical medium 14. Write engine 38 provides the predetermined spin rate to motor 34 from write strategy table 40 based on whether a single or multiple lasers are used in the write. Making a mark on an optical medium requires a certain amount of energy so that combining the power of two or more lasers available in optical drive 12 allows more energy to be imparted per unit of time, thus allowing optical medium 14 to be spun at a faster rate compared with when a single laser is used. For example, if the identification information indicates a Blu-ray Disc high definition DVD optical medium having single and multi-laser write strategies, write engine 38 may select either strategy to write information to the optical medium. If a single laser strategy is selected, then only the blue laser selectively illuminates the optical medium spun at a predetermined rate to alter the reflective material in a pattern that stores the information. If a multi-laser strategy is selected, then optical medium is spun at a faster rate and the blue laser selectively illuminates the optical medium at a faster rate to store information on the optical medium more quickly. The faster spin rate is enabled by preheating of the optical medium managed by a preheat engine 44. Preheat engine 44 uses infrared laser 26 and/or red laser 28 to illuminate the optical medium proximate the illumination of blue laser 30. The energy from infrared laser 26 and/or red laser 28 is insufficient to alter the reflective material of the optical medium but reduces the power needed for blue laser 30 to alter the reflective material, thus requiring reduced exposure of the optical medium to blue laser 30 by using a more rapid spin rate. Similarly, writes to CD or DVD media with infrared laser 26 or red laser 28 may be aided by preheating with blue laser 30. In one embodiment, multiple lasers of the same type, such as multiple blue lasers, are included in an optical head, with one or more selected to preheat and one or more selected to write information.

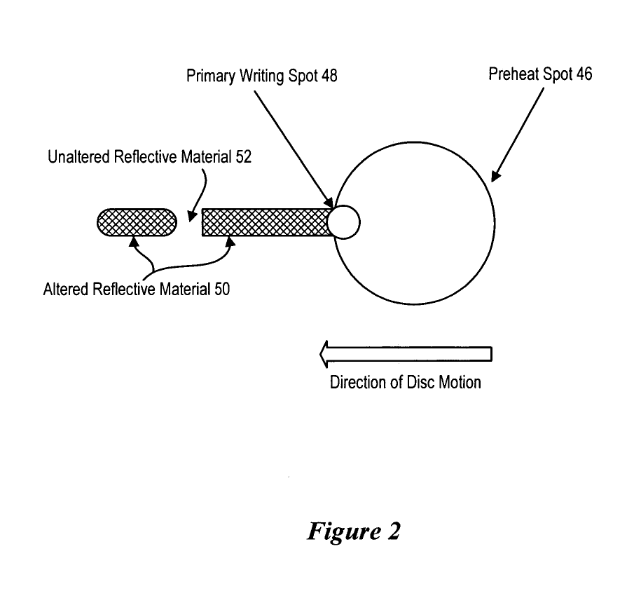

Referring now to FIG. 2, a preheat spot 46 and writing spot 48 are depicted illuminated on an optical medium for writing information to the optical medium. Information is stored on the optical medium as altered reflective areas 50 and unaltered reflective areas 52 based on the power of the primary writing laser at primary writing spot 48 as the optical medium moves proximate the laser. Preheat spot 46 is illuminated with a non-writing secondary laser that has insufficient power to alter the reflective material. Preheat spot 46 preheats the reflective material as the optical medium spins so that as the material spins under primary writing spot 48 less energy is needed from the primary writing laser to alter the reflective material. The amount of energy imparted on the optical medium by preheat spot 46 is managed by preheat engine 44 with either predetermined passively controlled parameters or actively controlled parameters. Passive preheat parameters include the size of the preheat spot, which is adjusted by loosening or tightening the focus of the secondary laser or lasers, and the power applied by the secondary laser, which depends upon the power applied by the primary laser, the length and shape of secondary laser pulses, the spin rate and the material of the optical medium. Appropriate preheat parameters are selected for each type of optical medium by experimentation and stored in write strategy table 40. Actively controlled parameters are adjusted by monitoring the impact of preheat spot 46 and primary writing spot 48 on the optical medium with read and monitor engine 42 on the reflective material. Preheat engine 44 applies the monitored impact adjust preheat parameters to maintain effective support of the primary writing laser at as rapid a spin rate as practical. For instance, overheating of reflective material within preheat spot 46 results in a reduction of the preheat power, loosening of the focus of the secondary lasers or an increase in the spin rate of the optical medium to avoid damage to information stored on the optical medium. Although FIG. 2 depicts writes of information to a data side of an optical medium, multiple lasers also support more rapid writes to a label side of an optical medium by illuminating the label side with a preheat spot 46 and primary writing spot 48.

Although the present invention has been described in detail, it should be understood that various changes, substitutions and alterations can be made hereto without departing from the spirit and scope of the invention as defined by the appended claims.

What is claimed is:

1. A method for writing information to an optical medium, the method comprising:
illuminating the optical medium in a predetermined location with a first laser having a first power, the first power insufficient to alter the reflective characteristics for a write of information to the optical medium; and
illuminating the optical medium in the predetermined location with a second laser to selectively alter the reflective characteristics of the optical medium.

2. The method of claim I wherein optical medium predetermined location is an information-writing location.

3. The method of claim 1 wherein the optical medium predetermined location is a label-writing location.

4. The method of claim 1 wherein the first laser comprises an infrared laser and the second laser comprises a blue laser.

5. The method of claim 1 wherein the first laser comprises a red laser and the second laser comprises a blue laser.

6. The method of claim 1 wherein the first laser comprises an infrared laser and the second laser comprises a red laser.

7. The method of claim I wherein the first laser is associated with a first optical medium type, the second laser is associated with a second optical medium type, and the illuminated optical medium is of the second optical medium type.

8. The method of claim 7 further comprising:
loosening the focus of the first laser from a writing focus associated with writing by the first laser to an optical medium of the first type to a preheating focus associated with preheating by the first laser of the optical medium for subsequent writing by the second laser.

9. An optical drive comprising:
an optical head having at least first and second lasers and a pickup unit, each laser operable to illuminate an optical medium, the pickup unit operable to detect illumination emitted from the optical medium;
a motor operable to spin the optical medium proximate the optical head at variable spin rates;
a preheat engine interfaced with the optical head and operable to illuminate the optical medium with the first laser to preheat the optical medium; and
a write engine interfaced with the preheat engine, the optical head and the motor, the write engine operable to select a spin rate for the motor to spin the optical medium and to selectively illuminate the optical medium with the second laser to write information on the optical medium, the write engine selecting a predetermined spin rate for writing to the optical medium without illumination of the optical medium from the first laser and selecting an increased spin rate for writing information to the optical medium if the preheat engine illuminates the optical medium with the first laser.

10. The optical drive of claim 9 further comprising a monitor engine interfaced with the optical head and the preheat engine, the monitor engine operable to monitor illumination reflected from the optical medium to adjust the preheating applied by the preheat engine.

11. The optical drive of claim 9 further comprising a third laser associated with the optical head, the preheat engine operable to selectively illuminate the optical medium with either or both of the first and third lasers.

12. The optical drive of claim 9 wherein the first laser comprises an infrared laser, the second laser comprises a blue laser, and the optical medium comprises a high definition DVD.

13. The optical drive of claim 9 wherein the first laser comprises a red laser, the second laser comprises a blue laser, and the optical medium comprises a high definition DVD.

14. The optical drive of claim 9 wherein the first laser comprises an infrared laser, the second laser comprises a red laser and the optical medium comprises a DVD.

15. The optical drive of claim 9 wherein the optical medium comprises a labeling surface.

16. An information handling system comprising:
processing components operable to generate information; and
an optical drive interfaced with the processing components to accept the information, the optical drive having a motor to rotate an optical medium past plural lasers, two or more of the lasers operable to cooperatively write the information to the optical medium with one or more of the lasers illuminating the optical medium at a preheating spot with a preheating power and one of the lasers selectively illuminating the optical medium proximate the preheating spot with a writing power to write the information to the optical medium.

17. The information handling system of claim 16 wherein the lasers comprise an infrared laser operable to write to CD optical media and a blue laser operable to write to high definition DVD optical media.

18. The information handling system of claim 16 wherein the lasers comprise a red laser operable to write to DVD optical media and a blue laser operable to write to high definition DVD optical media.

19. The information handling system of claim 16 wherein the lasers comprise an infrared laser operable to write to CD optical media and a red laser operable to write to a DVD optical media.

20. The information handling system of claim 16 wherein the lasers comprise an infrared laser operable to write to CD optical media, a red laser operable to write to a DVD optical media and a blue laser operable to write to a high definition DVD optical media.
